(19) United States
(12) Patent Application Publication
(10) Pub. No.: US 2018/0199312 A1
(43) Pub. Date: Jul. 12, 2018

(54) Sidelink Information Transmission Device and Method and Communications System

(71) Applicant: FUJITSU LIMITED, Kawasaki-shi (JP)

(72) Inventors: Lianhai WU, Beijing (CN); Haibo XU, Beijing (CN); Hua ZHOU, Beijing (CN)

(73) Assignee: FUJITSU LIMITED, Kawasaki-shi (JP)

(21) Appl. No.: 15/915,644

(22) Filed: Mar. 8, 2018

Related U.S. Application Data
(63) Continuation of application No. PCT/CN2015/090746, filed on Sep. 25, 2015.

(51) Int. Cl. H04W 72/02; H04B 7/155

(52) U.S. Cl. CPC H04W 72/02; H04W 88/04; H04B 7/155

(57) ABSTRACT

A sidelink information transmission device and method and a communication system. The method includes: selecting a relay user equipment by a remote user equipment from one or more user equipments; and transmitting to a base station first resource request information used for requesting for allocating a sidelink resource; the first resource request information indicates that the remote user equipment and the relay user equipment have been paired. Hence, resource waste due to allocating a sidelink resource for remote user equipment but allocating no sidelink resource for paired relay user equipment may be avoided or reduced, or resource collision due to allocating overlapped sidelink resources for remote user equipment and paired relay user equipment may be avoided or reduced.

### CROSS REFERENCE TO RELATED APPLICATIONS

This application is a continuation application of International Application PCT/CN2015/090746 filed on Sep. 25, 2015, the entire contents of which are incorporated herein by reference.

### TECHNICAL FIELD

This disclosure relates to the field of communications technologies, and in particular to a sidelink information transmission device and method and a communications system.

### BACKGROUND

In recent years, wireless communications technologies have been developed rapidly, 3GPP standardization develops to Rel. 13, and key technologies include wide configuration of small cells, carrier aggregation (CA), a 3D multi-antenna technology (such as multiple input multiple output (MIMO)), and LTE enabling at an unlicensed band (such as licensed-assisted-access), etc.

A sidelink communications mode refers to that a packet does not need to pass a core network and a base station, and a communications link may be directly established between user equipments (such as UE 1 and UE 2) for communication. The sidelink communications may also be referred to as device to device (D2D) communications. And a sidelink discovery process is generally performed before performing sidelink communications. For example, UE 1 needs first to discover whether UE 2 is near before transmitting information to UE 2 in the sidelink communications mode.

FIG. 1 is a schematic diagram of the sidelink communications, in which a case where two UEs (UE 1 and UE 2) under coverage of a base station (such as an eNB) perform sidelink discovery or establish sidelink communications is shown. FIG. 2 is another schematic diagram of the sidelink communications, in which a case where one UE (UE 1) under coverage of a base station and another UE (UE 2) not under the coverage of the base station perform sidelink discovery or establish sidelink communications is shown. And FIG. 3 is a further schematic diagram of the sidelink communications, in which a case where two UEs (UE 1 and UE 2) not under coverage of a base station perform sidelink discovery or establish sidelink communications is shown.

The sidelink communications mode may be used to expand coverage of a cell. Two examples of expanding coverage are given below with reference to FIGS. 1 and 2.

Scenario 1: as shown in FIG. 1, a UE (UE 2) is located at an edge of a cell, and its signals are relatively weak, which is very possible to leave coverage of the cell. Furthermore, there exists a UE (such as UE 1) nearby which is authorized by a network and has a function of relay. And in order to avoid traffic interruption, UE 2 may access a base station via the relay UE (UE 1) after discovering the relay UE (UE 1), and proceed with performing normal traffic communications.

Scenario 2: as shown in FIG. 2, a UE (such as UE 2) is located in an area with no network coverage, and there exists a UE (such as UE 1) nearby which is authorized by a network and has a function of relay. In order to access to a network for communication, UE 2 may access a base station via the relay UE (UE 1) after discovering the relay UE (UE 1) within coverage of a cell.

In the above-described scenarios, UE 2 may be referred to as a remote UE, which may be located within coverage of a cell, or may be located out of the coverage of the cell. And a UE having a function of relay (such as UE 1) may be referred to a relay UE, or may be referred to as a UE-network relay, or may also be referred to as a relay.

Furthermore, if a remote UE and a relay UE are selected (such as being selected by the remote UE itself, or being selected by a base station, etc.) to perform sidelink communications, it may be referred to as that the remote UE and the relay UE have been paired.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in an existing system, it is possible that a base station allocates a sidelink resource for the remote user equipment, but does not allocate a sidelink resource for the paired relay user equipment, which will result in waste of resources; or the base station allocates overlapped sidelink resources for the remote user equipment and the paired relay user equipment, which will result in resource collision.

Embodiments of this disclosure provide a sidelink information transmission device and method and a communications system, in which resource waste or resource collision may be avoided or reduced by transmitting information that the remote user equipment and the relay user equipment have been paired to the base station.

According to a first aspect of the embodiments of this disclosure, there is provided a sidelink information transmission method, applicable to a remote user equipment, the sidelink information transmission method including:

selecting a relay user equipment by the remote user equipment from one or more user equipments; and

transmitting to a base station first resource request information used for requesting for allocating a sidelink resource; the first resource request information indicates that the remote user equipment and the relay user equipment have been paired.

According to a second aspect of the embodiments of this disclosure, there is provided a sidelink information transmission device, configured in a remote user equipment, the sidelink information transmission device including:

a relay selecting unit configured to select a relay user equipment from one or more user equipments; and

a first request transmitting unit configured to transmit to a base station first resource request information used for requesting for allocating a sidelink resource; the first resource request information indicates that the remote user equipment and the relay user equipment have been paired.

According to a third aspect of the embodiments of this disclosure, there is provided a sidelink information transmission method, applicable to a relay user equipment, the sidelink information transmission method including:

transmitting to a base station by the relay user equipment second resource request information for requesting for allocating a sidelink resource; the second resource request information indicates that the relay user equipment and one or more remote user equipments have been paired.

According to a fourth aspect of the embodiments of this disclosure, there is provided a sidelink information transmission device, configured in a relay user equipment, the sidelink information transmission device including:

a second request transmitting unit configured to transmit to a base station second resource request information for requesting for allocating a sidelink resource; the second resource request information indicates that the relay user equipment and one or more remote user equipments have been paired.

According to a fifth aspect of the embodiments of this disclosure, there is provided a communications system, including a remote user equipment, a relay user equipment and a base station;

the remote user equipment is configured to select the relay user equipment from one or more user equipments, and transmit to the base station first resource request information for requesting for allocating a sidelink resource; and the first resource request information indicates that the remote user equipment and the relay user equipment have been paired;

or, the relay user equipment is configured to transmit to the base station second resource request information for requesting for allocating a sidelink resource; and the second resource request information indicates that the relay user equipment and one or more remote user equipments have been paired.

According to another aspect of the embodiments of this disclosure, there is provided a computer readable program code, which, when executed in a base station, will cause a computer unit to carry out the sidelink information transmission method as described above in the base station.

According to a further aspect of the embodiments of this disclosure, there is provided a computer readable medium, including a computer readable program code, which will cause a computer unit to carry out the sidelink information transmission method as described above in a base station.

According to still another aspect of the embodiments of this disclosure, there is provided a computer readable program code, which, when executed in a UE, will cause a computer unit to carry out the sidelink information transmission method as described above in the UE.

According to yet another aspect of the embodiments of this disclosure, there is provided a computer readable medium, including a computer readable program code, which will cause a computer unit to carry out the sidelink information transmission method as described above in a UE.

An advantage of the embodiments of this disclosure exists in that the base station may allocate suitable resources for the paired remote user equipment and relay user equipment by transmitting information that the remote user equipment and the relay user equipment have been paired to the base station by the remote user equipment or the relay user equipment. Hence, resource waste due to allocating a sidelink resource for the remote user equipment but allocating no sidelink resource for paired relay user equipment may be avoided or reduced, or resource collision due to allocating overlapped sidelink resources for the remote user equipment and paired relay user equipment may be avoided or reduced.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of sidelink communications;

FIG. 2 is another schematic diagram of the sidelink communications;

FIG. 3 is a further schematic diagram of the sidelink communications;

FIG. 4 is a flowchart of the sidelink information transmission method of Embodiment 1 of this disclosure;

FIG. 5 is another flowchart of the sidelink information transmission method of Embodiment 1 of this disclosure;

FIG. 6 is a flowchart of the sidelink information transmission method of Embodiment 2 of this disclosure;

FIG. 7 is another flowchart of the sidelink information transmission method of Embodiment 2 of this disclosure;

FIG. 8 is a further flowchart of the sidelink information transmission method of Embodiment 2 of this disclosure;

FIG. 9 is a schematic diagram of the sidelink information transmission device of Embodiment 3 of this disclosure;

FIG. 10 is a schematic diagram of the UE of Embodiment 3 of this disclosure;

FIG. 11 is another schematic diagram of the sidelink information transmission device of Embodiment 3 of this disclosure;

FIG. 12 is a schematic diagram of the base station of Embodiment 3 of this disclosure;

FIG. 13 is a schematic diagram of the sidelink information transmission device of Embodiment 4 of this disclosure;

FIG. 14 another schematic diagram of the sidelink information transmission device of Embodiment 4 of this disclosure; and

FIG. 15 is a schematic diagram of the communications system of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

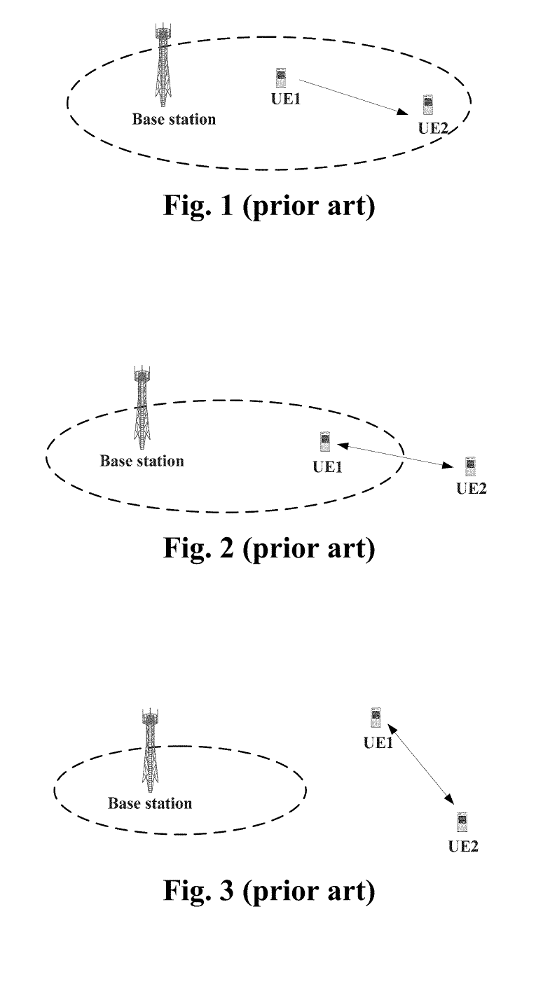

Taking the scenario shown in FIG. 1 as an example, after discovering and selecting a relay UE (UE 1), a remote UE (UE 2) in the coverage of the cell will transmit information informing the base station that it has selected the relay UE (UE 1). And after receiving the information, the base station will allocate a sidelink resource for the remote UE (UE 2).

The remote UE (UE 2) may transmit to the selected relay UE (UE 1) on the allocated resource a request for establishing sidelink connection. And after receiving the information, the relay UE (UE 1) will transmit request information for requesting a sidelink resource to the base station.

After receiving the request information transmitted by the relay UE (UE 1), the base station, in a case where it does not know that the remote UE (UE 2) and the relay UE (UE 1) are paired UEs, may reject to allocate a sidelink resource for the relay UE (UE 1) on account of insufficient resources. Hence, a case that the base station has already allocated a sidelink resource for the remote UE (UE 2), but does not allocate a sidelink resource for the relay UE (UE 1) may be caused, which may result in waste of resources.

Furthermore, after receiving the request information transmitted by the relay UE (UE 1), the base station, in a case where it does not know that the remote UE (UE 2) and the relay UE (UE 1) are paired UEs, the base station may possibly allocate overlapped sidelink resources for the remote UE (UE 2) and the relay UE (UE 1), which may result in resource collision.

Embodiments of this disclosure shall be described below in detail. It should be noted that the embodiments of this disclosure shall be described by taking the scenario shown in FIG. 1 as an example. However, this disclosure is not limited thereto; for example, they are also applicable to other scenarios.

### Embodiment 1

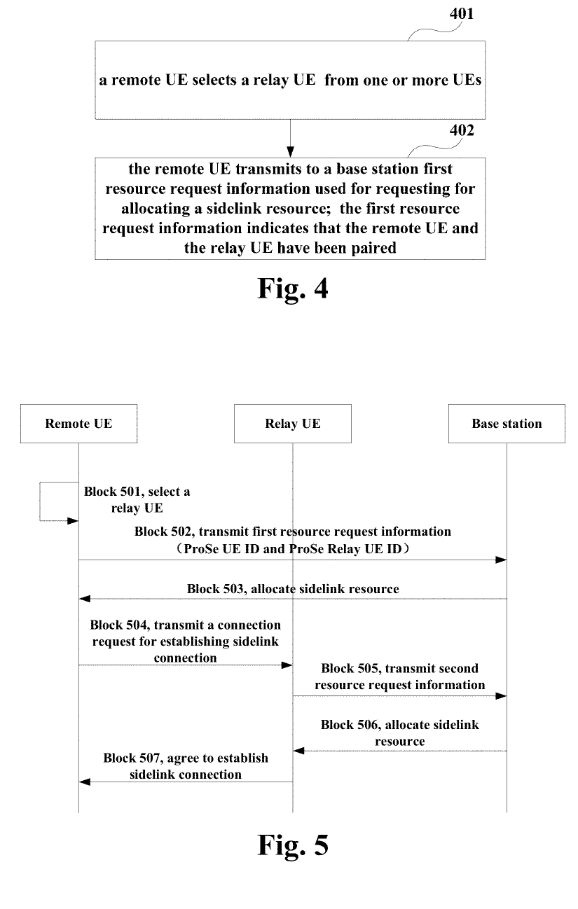

The embodiment of this disclosure provides a sidelink information transmission method. FIG. 4 is a flowchart of the sidelink information transmission method of this embodiment, which shall be described from a remote UE side.

As shown in FIG. 4, the sidelink information transmission method includes:

Block 401: a remote user equipment selects a relay user equipment from one or more user equipments; and

Block 402: the remote user equipment transmits to a base station first resource request information used for requesting for allocating a sidelink resource; the first resource request information indicates that the remote user equipment and the relay user equipment have been paired.

In this embodiment, the remote user equipment may select the relay user equipment in a case where air-interface signal strength is lower than a preconfigured threshold; however, this disclosure is not limited thereto, and the relay user equipment may also be selected under other triggering conditions. The relay user equipment is a user equipment having a function of relaying, that is, it pre-obtains a grant from a ProSe function entity, and has a ProSe relay UE ID.

In this embodiment, the first resource request information may include an ID of a transmitting user equipment and an ID of a paired target user equipment, which in the request information, appear as, for example, a ProSe UE ID of the remote user equipment and a ProSe relay UE ID of the relay user equipment, and the relevant art may be referred for details of the ProSe UE ID and the ProSe relay UE ID.

Hence, what is different from the relevant art is that in the embodiment of this disclosure, the resource request information may be used to indicate that the remote user equipment and the relay user equipment have been paired (for example, the resource request information includes the ProSe UE ID and the ProSe relay UE ID). Hence, the base station may learn information on the sidelink paired user equipment, and may allocate suitable resources for the remote user equipment and the relay user equipment.

FIG. 5 is another flowchart of the sidelink information transmission method of this embodiment. As shown in FIG. 5, the sidelink information transmission method includes:

Block 501: a remote user equipment selects a relay user equipment;

in this embodiment, the remote user equipment has a ProSe UE ID, and the relay user equipment has a ProSe relay UE ID; for example, the remote user equipment may detect sidelink discovery signals transmitted by one or more UEs, select one relay user equipment therefrom according to a preset condition, and obtain a ProSe relay UE ID of the relay user equipment.

Block 502: the remote user equipment transmits to a base station first resource request information used for requesting for allocating a sidelink resource; the first resource request information includes an ID of a transmitting user equipment and an ID of a target user equipment, which in the request information, appear as, for example, the ProSe UE ID and the ProSe relay UE ID.

Block 503: the base station allocates a suitable sidelink resource for the remote user equipment.

Block 504: the remote user equipment transmits on the allocated sidelink resource to the relay user equipment, a connection request for establishing sidelink connection;

the request information, for example, may further contain a cell radio network temporary identifier (C-RNTI) of the remote user equipment.

Block 505: the relay user equipment transmits second resource request information for request allocation a sidelink resource to the base station;

in this embodiment, after the relay user equipment receives the connection request from the remote user equipment, if the relay user equipment agrees to establish sidelink connection, the relay user equipment transmits the request information to the base station for allocating a resource used for sidelink transmission.

Block 506: the base station allocates a suitable sidelink resource for the relay user equipment;

in this embodiment, after receiving the request information transmitted by the relay user equipment, the base station may decide whether to allocate a resource and what resource is to be allocated for the relay user equipment, and if the base station agrees to allocate a resource, the base station may, according to the information obtained in block 502, allocate a suitable sidelink resource for the relay user equipment for communication;

for example, the base station may possibly allocate for the relay user equipment a resource that is not overlapped with the resource for the remote user equipment, so as to avoid occurrence of collision in half-duplex remote user equipment or relay user equipment in transmission and reception.

Block 507: the relay user equipment feeds back to the remote user equipment agreement on establishing sidelink connection.

It should be noted that what described above is illustrative only; however, this disclosure is not limited thereto. For example, an order of execution of the blocks or steps shown FIG. 5 may be adjusted according to an actual situation, or one or more of the blocks or steps may be omitted.

It can be seen from the above embodiment that the remote user equipment may transmit information on being paired to the base station, and the base station may allocate suitable resources for the paired remote user equipment and relay user equipment, thereby avoiding or reducing resource waste due to allocating a sidelink resource for the remote user equipment but allocating no sidelink resource for the paired relay user equipment, or avoiding or reducing resource collision due to allocating overlapped sidelink resources for the remote user equipment and the paired relay user equipment.

### Embodiment 2

The embodiment of this disclosure provides a sidelink information transmission method, with contents identical to those in Embodiment 1 being not going to be described herein any further.

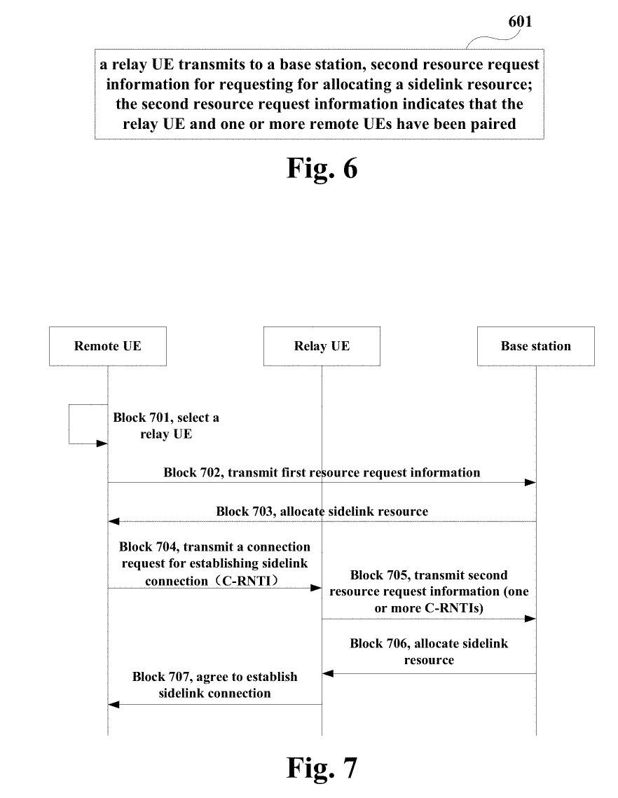

FIG. 6 is a flowchart of the sidelink information transmission method of this embodiment, which shall be described from a relay UE side.

As shown in FIG. 6, the sidelink information transmission method includes:

Block 601: a relay user equipment transmits to a base station, second resource request information for requesting for allocating a sidelink resource; the second resource request information indicates that the relay user equipment and one or more remote user equipments have been paired.

In one implementation, the second resource request information may contain cell radio network temporary identifier(s) (C-RNTI(s)) of the one or more remote user equipments. The relay user equipment may receive from the remote user equipment connection request information for establishing sidelink connection, the connection request information containing the C-RNTI of the remote user equipment.

FIG. 7 is another flowchart of the sidelink information transmission method of the embodiment of this disclosure. As shown in FIG. 7, the sidelink information transmission method includes:

Block 701: a remote user equipment selects a relay user equipment;

in this embodiment, the remote user equipment has a ProSe UE ID, and the relay user equipment has a ProSe relay UE ID; for example, the remote user equipment may detect sidelink discovery signals transmitted by one or more user equipments, select one relay user equipment therefrom according to a preset condition, and obtain a ProSe relay UE ID of the relay user equipment.

Block 702: the remote user equipment transmits to a base station, first resource request information used for requesting for allocating a sidelink resource;

for example, the first resource request information contains only the ProSe relay UE ID, but not the ProSe UE ID of the remote user equipment itself.

Block 703: the base station allocates a suitable sidelink resource for the remote user equipment.

Block 704: the remote user equipment transmits on the allocated sidelink resource to the relay user equipment, a connection request for establishing sidelink connection; connection request information containing a C-RNTI of the remote user equipment.

Block 705: the relay user equipment transmits second resource request information for request allocation a sidelink resource to the base station; the second resource request information containing a C-RNTI/C-RNTIs of one or more remote user equipments;

in this embodiment, after the relay user equipment receives the connection request from the remote user equipment, if the relay user equipment agrees to establish sidelink connection, the relay user equipment transmits the request information to the base station for allocating a resource used for sidelink transmission; for example, the relay user equipment may transmit a C-RNTI/C-RNTIs of one or more paired remote user equipments to the base station;

in this embodiment, as the remote user equipment is in a connected state, the C-RNTI of the remote user equipment is reserved in the base station; and after the base station receives the resource request information containing the C-RNTI of the remote user equipment and transmitted by the relay user equipment, the base station may learn that the relay user equipment and one or more paired remote user equipments have been paired.

Block 706: the base station allocates a suitable sidelink resource for the relay user equipment;

in this embodiment, after receiving the request information transmitted by the relay user equipment, the base station may decide whether to allocate a resource and what resource is to be allocated for the relay user equipment, and if the base station agrees to allocate a resource, the base station may, according to the information obtained in block 705, allocate a suitable sidelink resource for the relay user equipment for communication;

for example, the base station may possibly allocate a resource that is not overlapped with the resource for the remote user equipment for the relay user equipment, so as to avoid occurrence of collision in half-duplex remote user equipment or relay user equipment in transmission and reception.

Block 707: the relay user equipment feeds back to the remote user equipment agreement on establishing sidelink connection.

In another implementation, the second resource request information contains a ProSe UE ID/ProSe UE IDs of one or more remote user equipments and a ProSe relay UE ID of the relay user equipment.

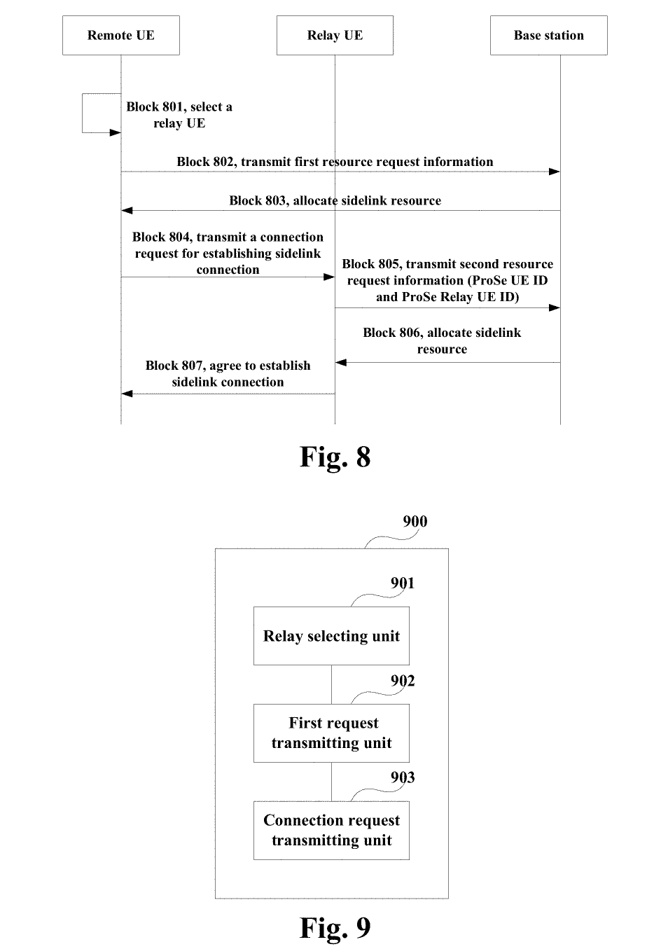

FIG. 8 is a further flowchart of the sidelink information transmission method of the embodiment of this disclosure. As shown in FIG. 8, the sidelink information transmission method includes:

Block 801: a remote user equipment selects a relay user equipment;

in this embodiment, the remote user equipment has a ProSe UE ID, and the relay user equipment has a ProSe relay UE ID; for example, the remote user equipment may detect sidelink discovery signals transmitted by one or more user equipments, select one relay user equipment therefrom according to a preset condition, and obtain a ProSe relay UE ID of the relay user equipment.

Block 802: the remote user equipment transmits to a base station, first resource request information used for requesting for allocating a sidelink resource;

for example, the first resource request information contains only the ProSe relay UE ID, but not the ProSe UE ID of the remote user equipment itself.

Block 803: the base station allocates a suitable sidelink resource for the remote user equipment.

Block 804: the remote user equipment transmits on the allocated sidelink resource to the relay user equipment, a connection request for establishing sidelink connection;

furthermore, the relay user equipment may also obtain a ProSe UE ID of the paired remote user equipment.

Block 805: the relay user equipment transmits second resource request information for request allocation a sidelink resource to the base station; the second resource request information containing a ID of a transmitting user equipment and a ID of a target user equipment, which appear as, for example, a ProSe UE ID/ProSe UE IDs of one or more remote user equipments and a ProSe relay UE ID of the relay user equipment in the request information;

in this embodiment, after the relay user equipment receives the connection request from the remote user equipment, if the relay user equipment agrees to establish sidelink connection, the relay user equipment transmits the request information to the base station for allocating a resource used for sidelink transmission.

Block 806: the base station allocates a suitable sidelink resource for the relay user equipment;

in this embodiment, after receiving the request information transmitted by the relay user equipment, the base station may decide whether to allocate a resource and what resource is to be allocated for the relay user equipment, and if the base station agrees to allocate a resource, the base station may, according to the information obtained in block 805, allocate a suitable sidelink resource for the relay user equipment for communication;

for example, the base station may possibly allocate a resource that is not overlapped with the resource for the remote user equipment for the relay user equipment, so as to avoid occurrence of collision in half-duplex remote user equipment or relay user equipment in transmission and reception.

Block 807: the relay user equipment feeds back to the remote user equipment agreement on establishing sidelink connection.

It should be noted that the above process is illustrative only; however, this disclosure is not limited thereto. For example, an order of execution of the blocks or steps shown FIG. 7 or 8 may be adjusted according to an actual situation, or one or more of the blocks or steps may be omitted.

It can be seen from the above embodiment that the remote user equipment may transmit information on being paired to the base station, and the base station may allocate suitable resources for the paired remote user equipment and relay user equipment, thereby avoiding or reducing resource waste due to allocating a sidelink resource for the remote user equipment but allocating no sidelink resource for the paired relay user equipment, or avoiding or reducing resource collision due to allocating overlapped sidelink resources for the remote user equipment and the paired relay user equipment.

### Embodiment 3

The embodiment of this disclosure provides a sidelink information transmission device, corresponding to the sidelink information transmission method described in Embodiment 1, with identical contents being not going to be described herein any further.

FIG. 9 is a schematic diagram of the sidelink information transmission device of Embodiment 3 of this disclosure, the device being configured in a remote user equipment. As shown in FIG. 9, the sidelink information transmission device 900 includes:

a relay selecting unit 901 configured to select a relay user equipment from one or more user equipments; and

a first request transmitting unit 902 configured to transmit to a base station first resource request information used for requesting for allocating a sidelink resource; the first resource request information indicates that the remote user equipment and the relay user equipment have been paired.

In this embodiment, the first resource request information may include an ID of a transmitting user equipment and an ID of a paired target user equipment, which, in the request information, appear as a ProSe UE ID of the remote user equipment and a ProSe relay UE ID of the relay user equipment.

In this embodiment, the relay selecting unit 901 may select the relay user equipment when an air-interface signal strength of the remote user equipment is lower than a preconfigured threshold.

As shown in FIG. 9, the sidelink information transmission device 900 may further include:

a connection request transmitting unit 903 configured to transmit to the relay user equipment connection request information for establishing a sidelink.

For example, the connection request information may further contain a C-RNTI of the remote user equipment.

It should be noted that FIG. 9 only schematically shows some components of the sidelink information transmission device related to this disclosure. However, this disclosure is not limited thereto, and the relevant art may be referred to for other components for sidelink information transmission, which shall not be described herein any further.

The embodiment of this disclosure further provides a UE, configured with the above sidelink information transmission device 900.

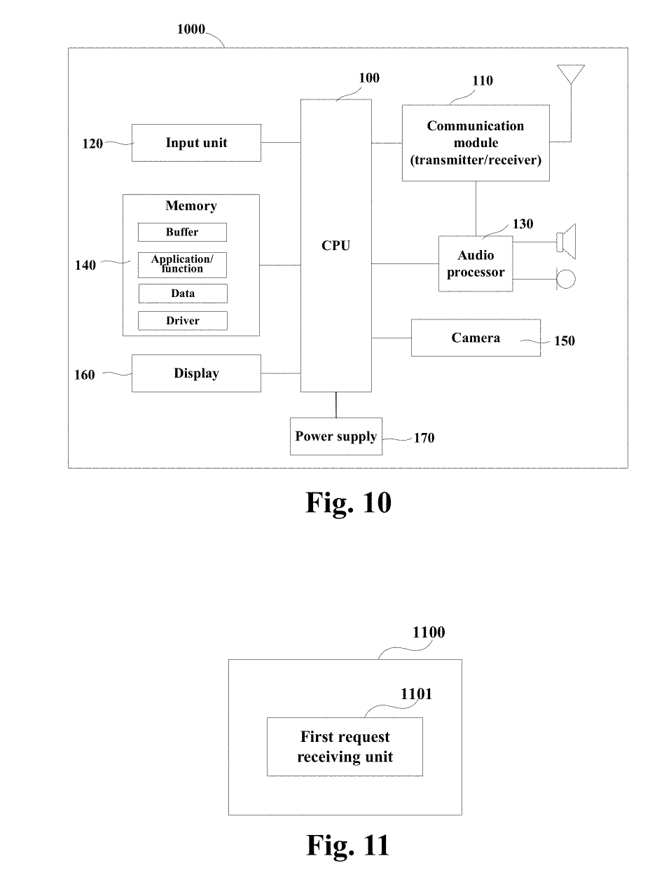

FIG. 10 is a schematic diagram of the UE of the embodiment of this disclosure. As shown in FIG. 10, the UE 1000 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the sidelink information transmission device 900 may be integrated into the central processing unit 100. The central processing unit 100 may be configured to carry out the sidelink information transmission method described in Embodiment 1.

In another implementation, the sidelink information transmission device 900 and the central processing unit 100 may be configured separately. For example, the sidelink information transmission device 900 may be configured as a chip connected to the central processing unit 100, with its functions being realized under control of the central processing unit.

As shown in FIG. 10, the UE 1000 may further include a communications module 110, an input unit 120, an audio processor 130, a memory 140, a camera 150, a display 160 and a power supply 170. Functions of the above components are similar to those in the relevant art, and shall not be described herein any further. It should be noted that the UE 1000 does not necessarily include all the parts shown in FIG. 10, and furthermore, the UE 1000 may include parts not shown in FIG. 10, and the relevant art may be referred to.

FIG. 11 is another schematic diagram of the sidelink information transmission device of the embodiment of this disclosure, which is configured in a base station. As shown in FIG. 11, the sidelink information transmission device 1100 includes:

a first request receiving unit 1101 configured to receive first resource request information used for requesting for allocating a sidelink resource and transmitted by a remote user equipment; the first resource request information indicates that the remote user equipment and the relay user equipment have been paired.

In this embodiment, the first resource request information may further contain an ID of a transmitting user equipment and an ID of a paired target user equipment, which, for example, in the request information, appear as a ProSe UE ID of the remote user equipment and a ProSe relay UE ID of the relay user equipment.

It should be noted that FIG. 11 only schematically shows some components of the sidelink information transmission device related to this disclosure. However, this disclosure is not limited thereto, and the prior art may be referred to for other components for sidelink information transmission, which shall not be described herein any further.

The embodiment of this disclosure further provides a base station, configured with the above sidelink information transmission device 1100.

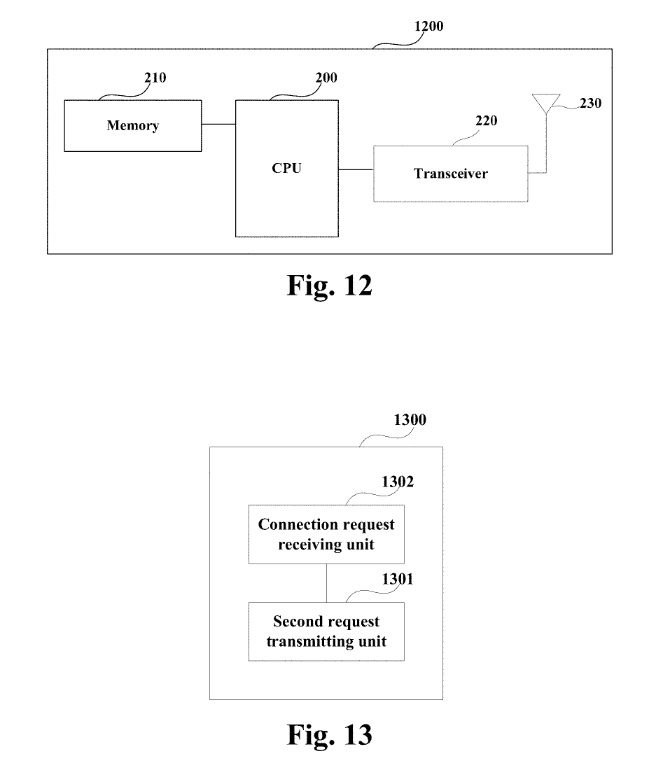

FIG. 12 is a schematic diagram of the base station of the embodiment of this disclosure. As shown in FIG. 12, the base station 1200 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The base station 1200 may carry out the sidelink information transmission method described in Embodiment 1. And the central processing unit 200 may be configured to carry out the functions of the sidelink information transmission device 1100.

Furthermore, as shown in FIG. 12, the base station 1200 may include a transceiver 220, and an antenna 230, etc. Functions of the above components are similar to those in the relevant art, and shall not be described herein any further. It should be noted that the base station 1200 does not necessarily include all the parts shown in FIG. 12, and furthermore, the base station 1200 may include parts not shown in FIG. 12, and the relevant art may be referred to.

It can be seen from the above embodiment that the remote user equipment may transmit information on being paired to the base station, and the base station may allocate suitable resources for the paired remote user equipment and relay user equipment, thereby avoiding or reducing resource waste due to allocating a sidelink resource for the remote user equipment but allocating no sidelink resource for the paired relay user equipment, or avoiding or reducing resource collision due to allocating overlapped sidelink resources for the remote user equipment and the paired relay user equipment.

### Embodiment 4

The embodiment of this disclosure provides a sidelink information transmission device, corresponding to the sidelink information transmission method described in Embodiment 2, with identical contents being not going to be described herein any further.

FIG. 13 is a schematic diagram of the sidelink information transmission device of the embodiment of this disclosure, the device being configured in a relay user equipment. As shown in FIG. 13, the sidelink information transmission device 1300 includes:

a second request transmitting unit 1301 configured to transmit to a base station second resource request information for requesting for allocating a sidelink resource; the second resource request information indicates that the relay user equipment and one or more remote user equipments have been paired.

In one implementation, the second resource request information may contain a C-RNTI(s) of the one or more remote user equipments.

As shown in FIG. 13, the sidelink information transmission device 1300 may further include:

a connection request receiving unit 1302 configured to receive from the remote user equipment connection request information for establishing a sidelink connection; the connection request information includes the C-RNTI of the remote user equipment.

In another implementation, the second resource request information may contain an ID of a transmitting user equipment and an ID of a paired target user equipment, which, for example, in the request information, appear as a ProSe UE ID/ProSe UE IDs of one or more remote user equipments and a ProSe relay UE ID of the relay user equipment.

It should be noted that FIG. 13 only schematically shows some components of the sidelink information transmission device related to this disclosure. However, this disclosure is not limited thereto, and the relevant art may be referred to for other components for sidelink information transmission, which shall not be described herein any further.

The embodiment of this disclosure further provides a UE, configured with the above sidelink information transmission device 1300. For example, a structure of the UE may be as shown in FIG. 10.

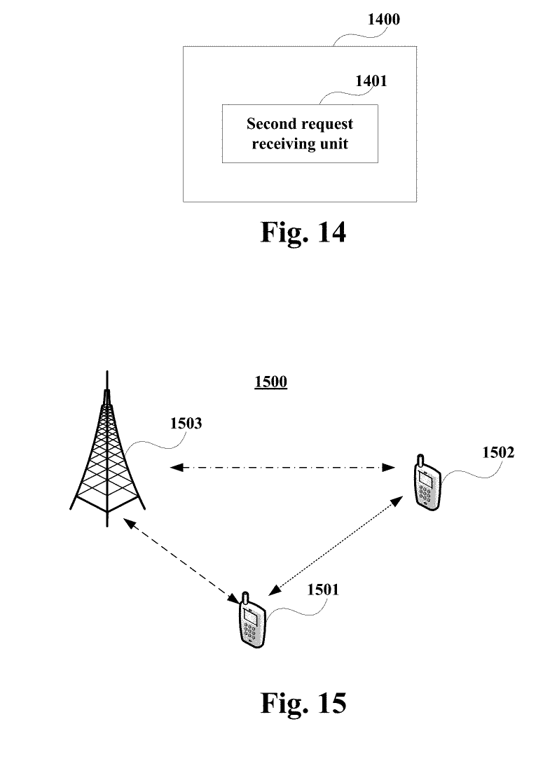

FIG. 14 a schematic diagram of the sidelink information transmission device of the embodiment of this disclosure, configured in a base station. As shown in FIG. 14, the sidelink information transmission device 1400 includes:

a second request receiving unit 1401 configured to receive second resource request information used for requesting for allocating a sidelink resource and transmitted by a relay user equipment; the second resource request information indicates that the relay user equipment and one or more remote user equipments have been paired.

It should be noted that FIG. 14 only schematically shows some components of the sidelink information transmission device related to this disclosure. However, this disclosure is not limited thereto, and the relevant art may be referred to for other components for sidelink information transmission, which shall not be described herein any further.

The embodiment of this disclosure further provides a base station, configured with the above sidelink information transmission device 1400. For example, a structure of the base station may be as shown in FIG. 12.

It can be seen from the above embodiment that the relay user equipment may transmit information on being paired to the base station, and the base station may allocate suitable resources for the paired remote user equipment and relay user equipment, thereby avoiding or reducing resource waste due to allocating a sidelink resource for the remote user equipment but allocating no sidelink resource for the paired relay user equipment, or avoiding or reducing resource collision due to allocating overlapped sidelink resources for the remote user equipment and the paired relay user equipment.

### Embodiment 5

The embodiment of this disclosure provides a communications system, with contents identical to those in embodiments 1-4 being not going to be described herein any further. FIG. 15 is a schematic diagram of the communications system of the embodiment of this disclosure. As shown in FIG. 15, the communications system 1500 includes: a remote user equipment 1501, a relay user equipment 1502 and a base station 1503.

In one implementation, the remote user equipment 1502 selects the relay user equipment 1501 from one or more user equipments, and transmits to the base station 1503 first resource request information for requesting for allocating a sidelink resource, the first resource request information indicating that the remote user equipment 1502 and the relay user equipment 1501 have been paired.

For example, the first resource request information may contain an ID of a transmitting user equipment and an ID of a paired target user equipment, which, for example, in the request information, appear as a ProSe UE ID of the remote user equipment and a ProSe relay UE ID of the relay user equipment.

In another implementation, the relay user equipment 1501 transmits to the base station 1503 second resource request information for requesting for allocating a sidelink resource; the second resource request information indicates that the relay user equipment 1501 and the remote user equipment 1502 have been paired.

For example, the second resource request information may contain the ID of the transmitting user equipment and the ID of the paired target user equipment, which, for example, in the request information, appear as C-RNTI(s) of the one or more remote user equipments 1502.

The relay user equipment 1501 may further receive connection request information for establishing a sidelink connection from the remote user equipment 1502; the connection request information contains a C-RNTI of the remote user equipment 1502.

In a further implementation, the relay user equipment 1501 transmits to the base station 1503 second resource request information for requesting for allocating a sidelink resource; the second resource request information indicates that the relay user equipment 1501 and the remote user equipment 1502 have been paired.

For example, the second resource request information may contain the ID of the transmitting user equipment and the ID of the paired target user equipment, which, for example, in the request information, appear as a ProSe relay UE ID of the relay user equipment 1501 and a ProSe UE ID/ProSe UE IDs of the one or more remote user equipments 1502.

An embodiment of the present disclosure provides a computer readable program code, which, when executed in a UE, will cause a computer unit to carry out the sidelink information transmission method described in Embodiment 1 or 2 in the UE.

An embodiment of the present disclosure provides a computer readable medium, including a computer readable program code, which will cause a computer unit to carry out the sidelink information transmission method described in Embodiment 1 or 2 in a UE.

An embodiment of the present disclosure provides a computer readable program code, which, when executed in a, will cause a computer unit to carry out the sidelink information transmission method described in Embodiment 1 or 2 in the base station.

An embodiment of the present disclosure provides a computer readable medium, including a computer readable program code, which will cause a computer unit to carry out the sidelink information transmission method described in Embodiment 1 or 2 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A sidelink information transmission device, configured in a remote user equipment (UE), the sidelink information transmission device comprising:
a relay selecting unit configured to select a relay user equipment from one or more user equipments; and
a first request transmitting unit configured to transmit to a base station first resource request information used for requesting for allocating a sidelink resource; wherein, the first resource request information indicates that the remote user equipment and the relay user equipment have been paired.

2. The sidelink information transmission device according to claim 1, wherein the first resource request information comprises an identifier (ID) of a transmitting user equipment and an identifier of a paired target user equipment.

3. The sidelink information transmission device according to claim 2, wherein in the first resource request information, the identifier of the transmitting user equipment and the identifier of the paired target user equipment appear as a ProSe UE ID of the remote user equipment and a relay UE ID of the relay user equipment.

4. The sidelink information transmission device according to claim 1, wherein the sidelink information transmission device further comprises:
a connection request transmitting unit configured to transmit to the relay user equipment connection request information for establishing a sidelink connection, the connection request information at least comprising a cell radio network temporary identifier (C-RNTI) of the remote user equipment.

5. A sidelink information transmission device, configured in a relay user equipment, the sidelink information transmission device comprising:
a second request transmitting unit configured to transmit to a base station second resource request information for requesting for allocating a sidelink resource; wherein the second resource request information indicates that the relay user equipment and one or more remote user equipments have been paired.

6. The sidelink information transmission device according to claim 5, wherein the second resource request information comprises cell radio network temporary identifier(s) (C-RNTI(s)) of the one or more remote user equipments.

7. The sidelink information transmission device according to claim 6, wherein the sidelink information transmission device further comprises:
a connection request receiving unit configured to receive from the remote user equipment connection request information for establishing a sidelink connection, wherein the connection request information comprises the C-RNTI of the remote user equipment.

8. The sidelink information transmission device according to claim 5, wherein the second resource request information comprises an identifier of a transmitting user equipment and an identifier of a paired target user equipment.

9. The sidelink information transmission device according to claim 8, wherein in the second resource request information, the identifier of the transmitting user equipment and the identifier of the target user equipment appear as a relay UE ID of the relay user equipment and ProSe UE ID(s) of the one or more remote user equipments.

10. A communications system, comprising a remote user equipment, a relay user equipment and a base station;
wherein, the remote user equipment is configured to select the relay user equipment from one or more user equipments, and transmit to the base station first resource request information for requesting for allocating a sidelink resource; and wherein the first resource request information indicates that the remote user equipment and the relay user equipment have been paired;
or, the relay user equipment is configured to transmit to the base station second resource request information for requesting for allocating a sidelink resource; and wherein the second resource request information indicates that the relay user equipment and one or more remote user equipments have been paired.

11. The communications system according to claim 10, wherein the first resource request information comprises an identifier of a transmitting user equipment and an identifier of a paired target user equipment.

12. The communications system according to claim 11, wherein in the first resource request information, the identifier of the transmitting user equipment and the identifier of the target user equipment appear as a ProSe UE ID of the remote user equipment and a relay UE ID of the relay user equipment.

13. The communications system according to claim 10, wherein the second resource request information comprises C-RNTI(s) of the one or more remote user equipments.

14. The communications system according to claim 11, wherein the relay user equipment further receives from the remote user equipment connection request information for establishing a sidelink connection; and wherein the connection request information comprises a C-RNTI of the remote user equipment.

15. The communications system according to claim 9, wherein the second resource request information comprises an identifier of a transmitting user equipment and an identifier of a paired target user equipment.

16. The communication system according to claim 15, wherein in the second resource request information, the identifier of the transmitting user equipment and the identifier of the target user equipment appear as a relay UE ID of the relay user equipment and ProSe UE ID(s) of the one or more remote user equipments.
